(19) United States
(12) Patent Application Publication
(10) Pub. No.: US 2019/0386950 A1
(43) Pub. Date: Dec. 19, 2019

(54) MESSAGE SHARING SYSTEM AND METHOD FOR INTERACTIVE APPLICATION

(71) Applicant: Gil Hoon Chang, Seoul (KR)

(72) Inventor: Gil Hoon Chang, Seoul (KR)

(21) Appl. No.: 16/485,520

(22) PCT Filed: Feb. 26, 2018
(86) PCT No.: PCT/KR2018/002322

§ 371 Date: Aug. 13, 2019

(30) Foreign Application Priority Data
Feb. 24, 2017 (KR) 10-2017-0024888

(51) Int. Cl. H04L 12/58

(52) U.S. Cl. CPC H04L 51/36; H04L 51/046

(57) ABSTRACT

The present invention relates to a message sharing system and method for an interactive chatting application, comprising: a message sharing server for sharing, with at least one heterogeneous application, all or some of messages transmitted/received in an interactive chatting application for chatting with at least one other user by exchanging messages with each other; and a message sharing device which is connected online to the message sharing server so as to receive a terminal's support for information for sharing the messages or information for executing a message sharing function.

### CROSS-REFERENCE TO RELATED APPLICATIONS

This Application is a continuation of PCT International Application S/N PCT/KR2018/002322 filed on Feb. 26, 2018 which is hereby incorporated in its entirety by reference.

### BACKGROUND OF THE INVENTION

### Field of the Invention

The present invention relates to a system and method for sharing a message of an interactive chatting application (APP), and more particularly, to a chatting APP message sharing system and method for sharing messages exchanged among users through a chatting APP with another APP.

### Description of the Related Art

These days, users install various APPs (or programs) on personal computers or mobile communication terminals (e.g., smart phones and tablets) and use the APPs.

For example, a mobile communication terminal can fundamentally perform basic voice communication. However, message-based chatting APPs (e.g., Messenger, Kakaotalk, and Line) based on data communication and various APPs for capturing and playing back pictures or videos through a camera, playing games, viewing broadcast programs, listening to music, online shopping, mobile banking, navigation, etc. are installed and used lately.

These APPs (or programs) improve user convenience but only operate independently of each other. There is a problem in that it is not possible to share information between the APPs (or programs).

For example, it is not possible to share messages exchanged among users who talk with each other through a chatting APP with another APP (e.g., a heterogeneous APP for capturing and playing back pictures or videos through a camera, playing games, viewing broadcast programs, listening to music, online shopping, mobile banking, navigation, or the like).

Assuming that users purchase goods and make payments for the goods as a group while communicating with each other (i.e., exchanging messages) through a chatting APP, each of the users should separately input a message of the same content (e.g., the name, brand, price, location, trade name, etc. of a product to be purchased) to respective APPs (e.g., the chatting APP, an online shopping APP, and a navigation APP) installed (or executed) on his or her mobile communication terminal to execute the respective APPs. For this reason, there are problems of poor user convenience (e.g., the inconvenience of repeatedly inputting the same message content) and poor continuity of conversation (e.g., it is necessary to proceed with a conversation after checking execution results of another APP).

In embodiments below, for convenience of description, the chatting APP (e.g., Messenger, Kakaotalk, and Line) may be referred to as a main APP, and APPs other than the chatting APP (e.g., different kinds of APPs for capturing and playing back pictures or videos through a camera, playing games, viewing broadcast programs, listening to music, online shopping, mobile banking, navigation, and the like) may be referred to as different kinds of APPs.

A background art of the present invention is disclosed in Unexamined Korean Patent Publication No. 10-2015-0137503 (“Method and System for Inserting Mobile Messenger Service into Other Application” published on Dec. 9, 2015).

### SUMMARY OF THE INVENTION

The present invention is directed to providing an interactive chatting application (APP) message sharing system and method for sharing messages exchanged among users who talk with each other through a chatting APP with another APP.

One aspect of the present invention provides a system for sharing a message of an interactive chatting application (APP), the system including a message sharing server configured to share, with at least one heterogeneous APP, all or some of messages exchanged in a chatting APP for communicating with at least one other user by exchanging messages; and a message sharing device configured to be connected online to the message sharing server and receive information for sharing the messages or information for executing a message sharing function from a terminal.

In the present invention, the message sharing server may be implemented to perform a function of detecting a specific word or keyword included in the messages exchanged through a chat channel of the chatting APP.

In the present invention, the message sharing server may divide a screen display area of the terminal into at least two window areas for display and display a screen in which messages of the chatting APP are exchanged and an execution screen of the heterogeneous APP or display an existing screen display area of the heterogeneous APP in common.

In the present invention, the message sharing server may be implemented to perform a function of detecting that a heterogeneous APP preset to share messages of the chatting APP is executed in each user's terminal.

In the present invention, the message sharing server may be implemented to generate a message in a preset format on the basis of execution results of the at least one heterogeneous APP and transmit the generated message through a chat channel of the chatting APP.

In the present invention, when a message including a word or keyword related to a pre-designated heterogeneous APP is detected in the messages exchanged through the chatting APP, the message sharing server may automatically execute the related heterogeneous APP or a heterogeneous APP server by using or inputting the word or keyword included in the detected message.

In the present invention, when execution of the heterogeneous APP or the heterogeneous APP server automatically executed by using the word or keyword is finished, the message sharing server may convert execution results of the heterogeneous APP into a pre-designated chatting message and output the pre-designated chatting message to a chat channel of the chatting APP.

In the present invention, the message sharing server may share the messages exchanged in the chatting APP with a corresponding heterogeneous APP or a corresponding heterogeneous APP server through an identifier pre-registered in a chat channel of the chatting APP.

Another aspect of the present invention provides a method of sharing a message of a chatting APP using a message sharing system including a message sharing server configured to share messages exchanged through a chatting APP with at least one heterogeneous APP and a message sharing device configured to be connected online to the message sharing server and receive information for sharing the messages or information for executing a message sharing function from a terminal, the method including: detecting, by the message sharing server, a message including a word or keyword related to at least one pre-designated heterogeneous APP in the messages exchanged through the chatting APP; and automatically executing, by the message sharing server, at least one corresponding heterogeneous APP or heterogeneous APP server by using the word or keyword included in the message.

In the present invention, to share the messages exchanged through the chatting APP with the heterogeneous APP, the message sharing server may divide a screen display area of the terminal into at least two display areas and display a screen in which messages of the chatting APP are exchanged and an execution screen of the heterogeneous APP or display an existing screen display area of the heterogeneous APP in common.

In the present invention, to share the messages exchanged through the chatting APP with the heterogeneous APP, the message sharing server may share the messages exchanged through the chatting APP with a corresponding heterogeneous APP or a corresponding heterogeneous APP server through an identifier pre-registered in a chat channel of the chatting APP.

In the present invention, the method may further include, when execution of the heterogeneous APP or the heterogeneous APP server automatically executed by using the word or keyword is finished, converting, by the message sharing server, execution results of the heterogeneous APP or the heterogeneous APP server into a pre-designated chatting message and outputting the pre-designated chatting message to a chat channel of the chatting APP.

In the present invention, to automatically execute the heterogeneous APP or the heterogeneous APP server, the message sharing server may apply, to the keyword, a weight calculated on the basis of the number of times that the same keyword has been mentioned and the number of users who have mentioned the same keyword in the messages exchanged through the chatting APP.

Another aspect of the present invention provides a method of sharing a message of a chatting APP using a message sharing system including a message sharing server configured to share messages exchanged through a chatting APP with at least one heterogeneous APP and a message sharing device configured to be connected online to the message sharing server and receive information for sharing the messages or information for executing a message sharing function from a terminal, the method including: receiving, by a heterogeneous APP server, a chat channel addition request message for requesting to add a service identifier of a heterogeneous APP or an identifier of the chatting APP to a chat channel as a group user through the heterogeneous APP in the terminal; transmitting, by the heterogeneous APP server, a chat channel creation request message for requesting to create a chat channel including, as interlocutors, group users who have been requested to be added to the chat channel as the group user to the chatting APP server; and creating, by the chatting APP server, a chat channel according to the chat channel creation request message and adding the service identifier of the heterogeneous APP in the terminal or the identifier of the chatting APP to the chat channel.

According to an aspect of the present invention, it is possible to share messages exchanged among users having a conversation through an interactive chatting application (APP) with another APP. Accordingly, the present invention can improve user convenience by making it unnecessary to repeatedly input the same message content to another APP and improve continuity of the conversation by making it possible to immediately check execution results of another APP during the conversation.

### BRIEF DESCRIPTION OF THE DRAWINGS

FIG. 1 is an example diagram illustrating a network configuration of a message sharing system according to an embodiment of the present invention.

FIG. 2 is an example diagram showing a schematic configuration of a message sharing device according to an embodiment of the present invention.

FIG. 3 is an example diagram showing a schematic configuration of a message sharing system according to another embodiment of the present invention.

FIG. 4 is a flowchart illustrating operation of a message sharing system according to a first embodiment of the present invention.

FIG. 5 is an example diagram illustrating operation of a message sharing system according to a second embodiment of the present invention.

FIG. 6 is an example diagram illustrating operation of a message sharing system according to a third embodiment of the present invention.

FIG. 7 is an example diagram illustrating operation of a message sharing system according to a fourth embodiment of the present invention.

FIG. 8 is an example diagram illustrating operation of a message sharing system according to a fifth embodiment of the present invention.

FIG. 9 is an example diagram illustrating operation of a message sharing system according to a sixth embodiment of the present invention.

### DETAILED DESCRIPTION OF EXEMPLARY EMBODIMENTS

Hereinafter, a system and method for sharing a message of an interactive chatting application (APP) according to an embodiment of the present invention will be described with reference to the accompanying drawings.

In this process, the thicknesses of lines or the sizes of elements shown in the drawings may be exaggerated for clarity and convenience of description. Further, the following terms are those defined in consideration of their functions in the present invention and may vary depending on an intention of a user or an operator, or customs. Therefore, the terms should be defined on the basis of the overall content of this specification.

For reference, the present invention may be implemented by inserting (or combining) a function of another APP (i.e., a heterogeneous APP) to functions of a main APP (i.e., a chatting APP) or vice versa, that is, by inserting (or combining) a function of a main APP (i.e., a chatting APP) to functions of another APP (i.e., a heterogeneous APP).

For example, the present invention may be implemented by adding a function of a main APP (e.g., a messenger function) to functions of a heterogeneous APP (e.g., an online shopping APP).

More preferably, however, the present invention may be implemented as a separate device and method for relaying (or transferring) messages (e.g., the overall message content or some message content) exchanged among users who talk with each other through a chatting APP to another APP (i.e., a heterogeneous APP executed in addition to the chatting APP in a terminal of a specific user who is participating in the chat) between respective APPs which are installed on mobile communication terminals and separately operate (i.e., the chatting APP and the heterogeneous APP) so that the messages can be shared with the heterogeneous APP.

Therefore, the system for sharing a message of a chatting APP according to this embodiment may be executed in the background and participate in a chat channel between users to share (i.e., sharing through message relay or transfer) messages exchanged among the users who talk with each other through the chatting APP with another APP (i.e., a heterogeneous APP). Also, the system may select all messages (e.g., all chatting sentences) or some messages (e.g., a specific word, image, sound, etc. appearing in the chat) corresponding to (e.g., a location on a map or a place name corresponding to a navigation APP) another APP (e.g., a heterogeneous APP for capturing and playing back pictures or videos through a camera, playing games, viewing broadcast programs, listening to music, online shopping, mobile banking, navigation, or the like) with which the messages will be shared and share the messages (i.e., sharing through message relay or transfer).

The system and method for sharing a message of a chatting APP according to this embodiment may be implemented in the form of a program (APP) installed on a personal computer or a mobile communication terminal, implemented to be connected in the form of a universal serial bus (USB) memory, a subscriber identity module (SIM) card, etc., implemented in the form of computing devices (or servers) connected via a network (or the Internet), or implemented in a combined form thereof.

A system for sharing a message of a chatting APP according to an embodiment of the present invention will be described below.

For convenience of description, the “system for sharing a message of a chatting APP” according to this embodiment of the present invention may also be simply referred to as a “message sharing system” below.

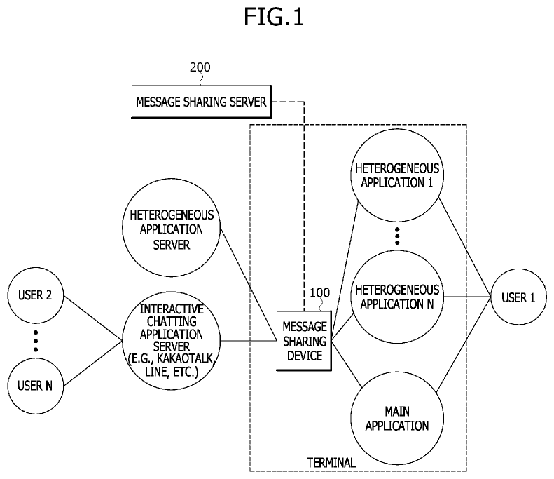

FIG. 1 is an example diagram illustrating a network configuration of a message sharing system according to an embodiment of the present invention.

As shown in FIG. 1, a message sharing device 100 or a message sharing server 200 according to this embodiment shares a terminal (e.g., a mobile communication terminal) with a specific user (e.g., user 1).

In other words, the message sharing device 100 according to this embodiment should be physically mounted or installed as software on a terminal (i.e., a mobile communication terminal) of each user (e.g., user 1, user 2, and user N).

Accordingly, the message sharing device 100 can share (or transfer or relay to a heterogeneous APP) all messages (e.g., chatting messages of a group of user 2 and user N), which are received through a chat channel accessed through one chatting APP (i.e., a main APP) installed on the terminal, with user 1.

Also, the message sharing device 100 may input (or paste) all (e.g., all chatting sentences) or some (e.g., some words or keywords in the message content) of the received messages to an information input window (e.g., a search window) of another APP (e.g., heterogeneous APP 1 or heterogeneous APP N) which is being executed in the terminal.

After inputting (or pasting) a message to the heterogeneous APP as described above, the message sharing device 100 may execute the heterogeneous APP.

For example, when the heterogeneous APP is a navigation APP, a route to a place input to the information input window (e.g., a search window) is retrieved, and when the heterogeneous APP is an online shopping APP, a product input to the information input window (e.g., a search window) is retrieved.

When a plurality of APPs (e.g., the chatting APP and the heterogeneous APP) are executed in the terminal as mentioned above, although not shown in detail in the drawing, the message sharing device 100 may divide a screen display area of the terminal (e.g., up/down division or left/right division), display an execution screen of the chatting APP in one display area, and display an execution screen of the heterogeneous APP in the other display area.

When two or more different kinds of APPs are simultaneously executed, the message sharing device 100 may divide the display area of the screen into as many display areas as the executed different kinds of APPs and display execution screens of designated APPs (e.g., the main APP and the different kinds of APPs) in the respective corresponding display areas.

However, when the terminal is smaller than a designated size (e.g., 7 inches or less) and the display area of the screen is divided as described above, a user may have difficulty in viewing or selecting an execution screen of each APP.

In this embodiment, to avoid such inconvenience, when the terminal is smaller than the designated size (e.g., 7 inches or less), an execution screen of a heterogeneous APP is displayed as a background image of the chatting APP such that the user can simultaneously see execution screens of a plurality of APPs (e.g., the chatting APP and one of the plurality of different kinds of APPs).

Also, the message sharing device 100 may be physically mounted or installed as software on the terminal shared with user 1 and separately executed. According to an embodiment (e.g., a case in which there is much data to be consulted), however, the message sharing device 100 may be executed in cooperation with the message sharing server 200 connected via a wired or wireless network (e.g., the Internet).

The message sharing system according to this embodiment should be understood as including the message sharing device 100 and the message sharing server 200.

For example, the message sharing device 100 may be mounted (or installed) in a terminal, and the message sharing server 200 may be mounted (or installed) in a main APP server (i.e., a chatting APP server).

In this embodiment, for convenience of description, construction means 110, 120, 140 to 160 of the message sharing device 100 are classified by function and described below, but in practice, a control unit 130 may execute all functions of the construction means 110, 120, 140 to 160 in an integrated manner. The control unit 130 may be implemented as a processor, such as a central processing unit (CPU) or a micro-processing unit (MPU), or implemented in the form of a program or algorithm for operation of the processor, such as a CPU or an MPU.

Although not described in detail in this embodiment, it is to be noted that specific functions of an already-known terminal or server may be used to perform functions of the respective construction means 110, 120, 140 to 160.

The construction means 110, 120, 140 to 160 of the message sharing device 100 may be applied as construction means of the message sharing server 200 as they are (however, the reference numerals may be changed). Also, when the message sharing server 200 is mounted (or installed) in the main APP server (i.e., the chatting APP server), specific functions of the main APP server (i.e., the chatting APP server) may be used.

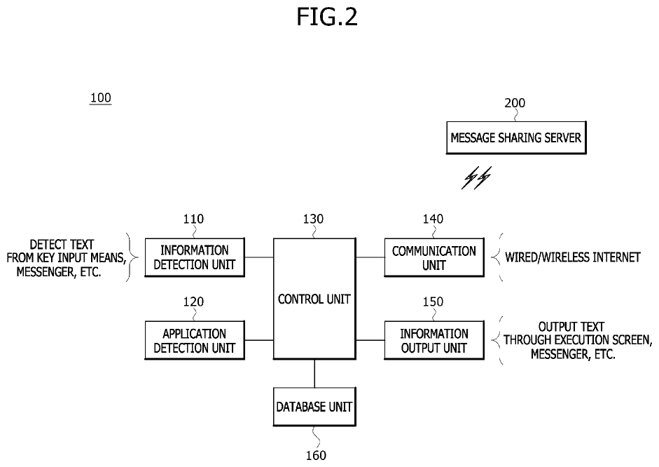

FIG. 2 is an example diagram showing a schematic configuration of a message sharing device according to an embodiment of the present invention.

As shown in FIG. 2, the message sharing device 100 according to this embodiment may include an information detection unit 110, an APP detection unit 120, a control unit 130, a communication unit 140, an information output unit 150, and a database unit 160. Also, the message sharing device 100 may additionally include the message sharing server 200 which is connected online.

The information detection unit 110 detects messages (e.g., text, images, and sound) exchanged through a key input means (e.g., a keyboard) of a terminal (e.g., a terminal in which the message sharing device is mounted or installed) or an execution screen of a chat APP.

The APP detection unit 120 detects a heterogeneous APP (e.g., a heterogeneous APP configured to share messages thereof) which is executed in the terminal (e.g., a terminal in which the message sharing device is mounted or installed) other than the chatting APP.

One or more different kinds of APPs may be configured to share the messages thereof, and the different kinds of APPs may be simultaneously executed.

The communication unit 140 is connected to the message sharing server 200 in a wired or wireless manner and requests or receives necessary information. Also, the communication unit 140 accesses a chat channel through the chatting APP and transmits and receives messages.

The information output unit 150 outputs messages (e.g., text, images, and sound) to an execution screen of the chatting APP or the heterogeneous APP.

For example, the output messages may be all or some of messages received through the chatting APP or messages of a pre-designated format (output format: “predicate”+“input information”+“heterogeneous APP,” e.g.: Search “Gangnam station” in the navigation APP) including information (e.g., a search word) manually input through an information input window (e.g., a search window) of the heterogeneous APP by a user.

The database unit 160 stores type information of different kinds of APPs related to meanings of messages exchanged through the chatting messages.

For example, when a message transmitted and received through the chatting messages is related to a “place,” information is related to a “navigation APP,” and when a message transmitted and received through the chatting messages is related to a “price,” information is related to a “online shopping mall APP.”

However, the meaning of a message is not necessarily limited to information related to one heterogeneous APP and may be information related to one or more different kinds of APPs.

When the meaning of a message is information related to one or more different kinds of APPs, the message may be input to an information input window (e.g., a search window) of a heterogeneous APP having higher correlation and may be executed in order of preset priority.

When a message (e.g., a keyword) related to a pre-designated heterogeneous APP is detected in messages exchanged through a chat channel of the chatting APP, the control unit 130 executes the corresponding heterogeneous APP (i.e., executes a fundamental function) by automatically inputting the message (e.g., a keyword) to an information input window (e.g., a search window) of the corresponding heterogeneous APP.

At this time, the control unit 130 may detect only a message (e.g., a keyword) related to a heterogeneous APP which has been being executed (running) already. Otherwise, when a message (e.g., a keyword) related to a heterogeneous APP which has not been being executed (running) yet but has been designated in advance is detected, the control unit 130 may automatically execute (i.e., run or activate) the corresponding APP and then execute the corresponding heterogeneous APP (e.g., search for a route or search for a product) by automatically inputting the keyword to the information input window (e.g., a search window) of the heterogeneous APP (e.g., a navigation APP or a shopping mall APP).

For reference, executing the heterogeneous APP by using a message to the information input window (e.g., a search window) of the heterogeneous APP is to execute a fundamental function of the heterogeneous APP while the heterogeneous APP is running (or activated) (e.g., when the heterogeneous APP is a navigation APP, a route search function which is a fundamental function thereof is executed). Also, the heterogeneous APP which has been being executed (running) denotes that the heterogeneous APP is running (activated) and is ready to execute the fundamental function.

To input the message to the information input window (e.g., a search window) of the corresponding heterogeneous APP (e.g., a navigation APP), the control unit 130 may consult information of the database unit 160. Alternatively, the control unit 130 may consult information received from the message sharing server 200.

Also, when a user manually inputs information through the information input window (e.g., a search window) of the heterogeneous APP, the control unit 130 may output (or transmit) a message of a pre-designated format (output format: “predicate”+“input information”+“heterogeneous APP,” e.g.: Search “Gangnam station” in the navigation APP) including the information (e.g., a search word) manually input by the user to a chat channel of the chatting APP.

Meanwhile, in this embodiment, the control unit 130 shares (relays or transfers) messages between the main APP (i.e., the chatting APP) and a heterogeneous APP in the following methods.

For example, a first method is push message transmission. According to this method, a server directly puts a message in a data area of a push frame and sends the push frame to a client. This method is characterized by real-time message transmission.

A second method is push notification transmission and message pulling request. According to this method, information representing that there is a new message or a message having not been transmitted is contained in a push message, a client is notified of the push message, and an actual data message is received by the client with a pulling request. In this case, the actual data message is basically pulled immediately after a push is received (real-time message sharing). In some service implementation methods, however, the actual data message may be pulled according to a schedule and occurrence of an event or on the request of a user.

A third method is polling request. According to this method, a client periodically requests a server to check whether there is a new message or a message having not been transmitted and receives a response. A message check request may be started by an input of a user, or a real-time message transfer characteristic of a server may be enhanced by long polling or the like.

In the above embodiment, a method in which the message sharing device 100 mounted (or installed) in a terminal shares messages between a user of a main APP and a heterogeneous APP has been described above. In other embodiments, the message sharing device 100 may not be mounted (or installed) in a terminal, or the message sharing device 100 may be mounted (or installed) in a terminal but perform only an auxiliary role (e.g., receiving a message transmitted by the server, receiving processing results from the server, or executing a heterogeneous APP designated by the server) to the message sharing server 200.

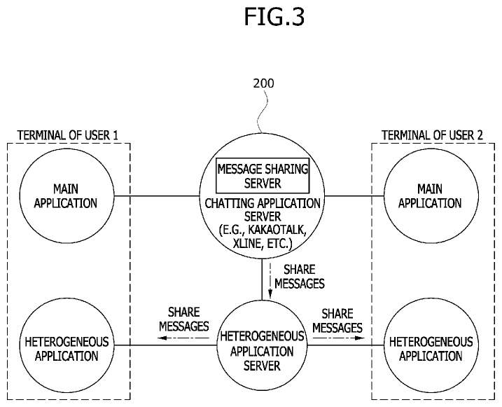

A method of sharing messages between users through a main APP server and a heterogeneous APP server centering on the message sharing server 200 will be described below with reference to FIG. 3.

FIG. 3 is an example diagram showing a schematic configuration of a message sharing system according to another embodiment of the present invention.

As shown in FIG. 3, the message sharing server 200 according to this embodiment may be implemented to be included in a main APP server (e.g., a chatting APP server). For example, the main APP server may perform a function of the message sharing server 200 according to this embodiment.

Therefore, an identifier of a heterogeneous APP may be registered in advance in the main APP server (i.e., a server performing a function of the message sharing server 200), and accordingly, messages exchanged among users through a chat channel may be shared with a heterogeneous APP server through the main APP server.

Also, when a previously registered specific word or keyword is detected in messages exchanged through the chat channel, the main APP server (i.e., a server performing a function of the message sharing server) may execute a corresponding function through a heterogeneous APP server related to the word or keyword and transmit execution results of the corresponding function to terminals of users participating in the chat channel and display the execution results.

In this case, information which is transmitted to the terminals and displayed (i.e., the execution results of the heterogeneous APP) may be transmitted in the form of an image which can be directly displayed in an execution screen of the main APP or transmitted in the form of information which can be displayed in an execution screen of the heterogeneous APP executed in the terminals.

In other words, the main APP server (i.e., a server performing a function of the message sharing server) according to this embodiment may share messages in direct cooperation with the heterogeneous APP, execute a function of the heterogeneous APP server and share execution results in the form of a message through the chat channel, or execute the heterogeneous APP in the terminal and output execution results of the heterogeneous APP server.

Therefore, although the operation will be described below centering on the message sharing device 100 for convenience, it may be understood that the message sharing device 100 mounted (or installed) in the terminal is operated under control of the message sharing server 200 in practice.

A method in which the message sharing device 100 (i.e., a message sharing device encompassing the message sharing server 200) determines whether to share (relay or transfer) a message of the main APP with a heterogeneous APP according to this embodiment will be described in further detail below.

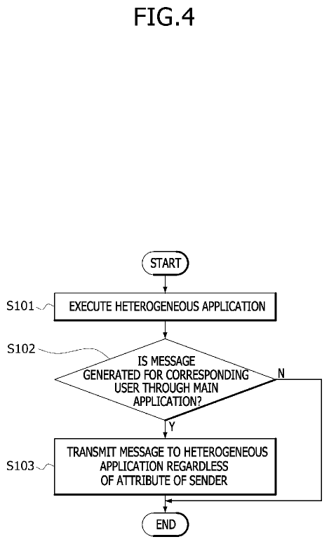

FIG. 4 is a flowchart illustrating operation of a message sharing system according to a first embodiment of the present invention.

While a user is executing a heterogeneous APP in a terminal (i.e., a state in which the corresponding APP is operating in a random access memory (RAM) regardless of activation (display) of an execution screen) (S101), a message may be generated for the user through a main APP (i.e., a chatting APP) (Yes in S102). Then, the message sharing device 100 (i.e., a message sharing device encompassing the message sharing server 200) according to this embodiment transmits the generated message to the heterogeneous APP in the terminal of the user regardless of an attribute of a sender (S103).

The attribute of a sender is information (e.g., an identifier) representing which one of a user of the heterogeneous APP, a user who receives the message, and a group service user of the heterogeneous APP is the sender.

Accordingly, the heterogeneous APP can receive the same message as received through the main APP (i.e., the chatting APP) using at least one of the above-described message sharing (relay or transfer) methods (e.g., a push message, a push notification, and a polling request) with respect to the message generated through the main APP.

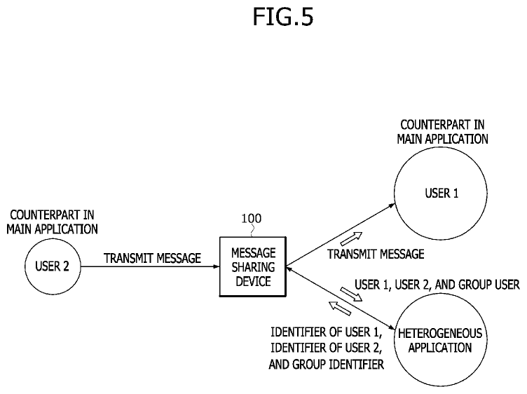

FIG. 5 is an example diagram illustrating operation of a message sharing system according to a second embodiment of the present invention.

As shown in FIG. 5, when a counterpart user (i.e., user 2) set as a co-user (i.e., user 1) in a heterogeneous APP executed in a terminal generates a message using a main APP, the message sharing device 100 (i.e., a message sharing device encompassing the message sharing server 200) transmits the generated message to the heterogeneous APP as well as user 1 (i.e., the main APP of user 1) at a time.

For example, when the heterogeneous APP is a payment APP for group purchase, users who will use operation (functionality) of the message sharing device 100 of this embodiment as a group are set as counterparts (i.e., counterparts to whom a message will be transferred) in the payment APP for group purchase.

In this case, identification information (i.e., identifiers) for identifying the group users is registered in the message sharing device 100 or the message sharing server 200.

Accordingly, the message sharing device 100 or the message sharing server 200 transmits messages generated in the main APP (i.e., a chatting APP) among the group users whose identifiers have been registered to the heterogeneous APP, that is, the payment APP for group purchase, of the users.

Meanwhile, although not shown in detail in FIG. 5, when the counterpart co-user (i.e., user 1) of the heterogeneous APP generates a message to be transmitted to the chat channel through the main APP (i.e., the chatting APP), the message sharing device 100 (i.e., the message sharing device 100 encompassing the message sharing server 200) transmits the generated message to the heterogeneous APP in which the identifiers have been registered.

Accordingly, the heterogeneous APP can also share the message generated by the counterpart co-user (i.e., user 1).

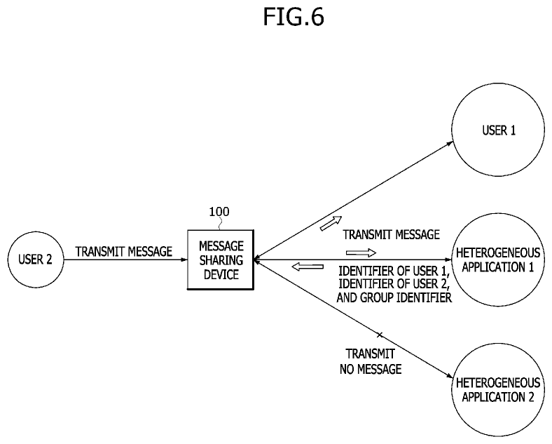

FIG. 6 is an example diagram illustrating operation of a message sharing system according to a third embodiment of the present invention.

As shown in FIG. 6, according to this embodiment, when an identifier of a heterogeneous APP executed in a terminal (e.g., an APP identifier or a service identifier of the heterogeneous APP) belongs to a chat channel (or a chat group) of a main APP, the message sharing device 100 (i.e., a message sharing device encompassing the message sharing server 200) transmits messages generated among users in the chat channel to the heterogeneous APP executed in terminals of the users as well.

For example, when a heterogeneous APP service (i.e., an application service performed using the heterogeneous APP) is included in a chat channel of the users (i.e., a chat channel using the main APP), a person in charge of the heterogeneous APP service (e.g., a manager of a service terminal performed using the heterogeneous APP) may be included as an interlocutor.

Assuming that two or more different kinds of APPs (e.g., heterogeneous APP 1 and heterogeneous APP 2) are executed in a terminal of each user, the message sharing device 100 does not share a message generated in the main APP with a heterogeneous APP (e.g., heterogeneous APP 2) whose identifier has not been registered in the chat channel. In other words, the message sharing device 100 does not share a message with the heterogeneous APP (e.g., heterogeneous APP 2) whose identifier has not been registered in advance.

Meanwhile, when an identifier of a heterogeneous APP participates in the chat channel of users as an interlocutor in the main APP (i.e., the chatting APP), the message sharing device 100 also communicates (i.e., exchanges messages) with the heterogeneous APP corresponding to the identifier. Accordingly, a conversation among the users is shared in a chat window of the heterogeneous APP (i.e., a window screen for message transmission and reception of the heterogeneous APP).

According to another embodiment, while group users (e.g., group purchasers of a shopping mall) are communicating with an interlocutor (e.g., a manager or a chat bot) of a heterogeneous APP service provider (e.g., a heterogeneous APP server) in the chat channel through the main APP (i.e., the chatting APP), it is possible to invite a new user.

Accordingly, when the invited new user accepts the invitation, the conversation with the chat bot (i.e., a message response robot which automatically responds to a message input by a user) can be shared with the new user like the group users. In other words, when the new user accepts the invitation of the main APP (i.e., the chatting APP), a group invitation function of the heterogeneous APP (e.g., a shopping mall APP), that is, an invitation for forming a group even in the heterogeneous APP, may be provided to the new user as well.

As described above, when a new user is invited in the main APP (i.e., the chatting APP) and accepts the invitation (i.e., participates in the chat channel), an invitation is transmitted to the new user so that the new user may join a group even in a heterogeneous APP, or the user is automatically made to join the group. Consequently, the new user may be made to join groups of the both APPs (i.e., the main APP and the heterogeneous APP).

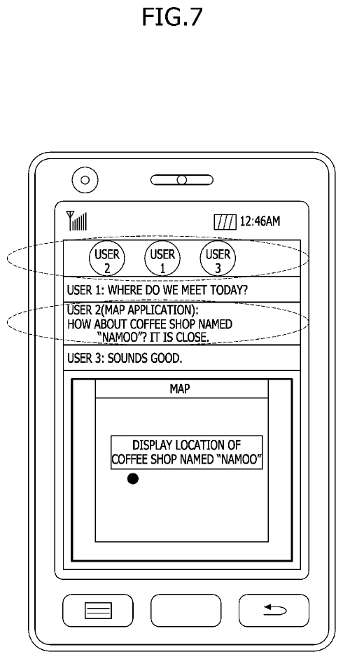

FIG. 7 is an example diagram illustrating operation of a message sharing system according to a fourth embodiment of the present invention.

The message sharing device 100 according to this embodiment analyzes words (or keywords) in a message delivered through a chat channel of a main APP (i.e., a chatting APP). When correlation analysis (i.e., analysis on whether there is an associated heterogeneous APP) is conducted or a word is mapped to a tagged word or a labeled word among words in the message during analysis of the words (or keywords), the message sharing device 100 transmits the message to the corresponding (i.e., associated) heterogeneous APP while searching for and selecting the associated heterogeneous APP or transmits the message while recommending the corresponding (i.e., associated) heterogeneous APP.

For example, as shown in FIG. 7, when three users talk about a location (e.g., a meeting place) through a chat channel of a main APP, the message sharing device 100 (i.e., a message sharing device encompassing the message sharing server 200) according to this embodiment recognizes the conversation (i.e., recognizes sentences, words, keywords, etc. included in messages), runs or recommends a heterogeneous APP (e.g., a map APP or a navigation APP) for performing an associated function (or a service) among different kinds of APPs in a push manner, and shares the conversation of the three users in the heterogeneous APP (e.g., the map APP or the navigation APP).

In other words, when an identifier of the map APP (i.e., the heterogeneous APP) is included as an interlocutor among interlocutors of the chat channel of the main APP, the message sharing device 100 (or a chat bot of the map APP) understands the conversation transmitted through the chat channel and responds to the conversation in text (i.e., a message). In this case, the message sharing device 100 may serve as a chat bot and participates in the chat channel by outputting a message of a designated format (e.g., a dialogic style) on the basis of execution (e.g., location search) results of the corresponding APP (e.g., the map APP).

As described above, according to this embodiment, the map APP interoperates with the chat channel of the main APP such that chatting messages are shared. Therefore, it is possible to make a response (e.g., a response using a message in the chat channel) with a function of a map service.

In other words, assuming that the users have a conversation through the main APP to find the location of a destination, the message sharing device 100 (i.e., a message sharing device encompassing the message sharing server 200) automatically executes the map APP (i.e., a heterogeneous APP) to find and display the location of the destination on a map.

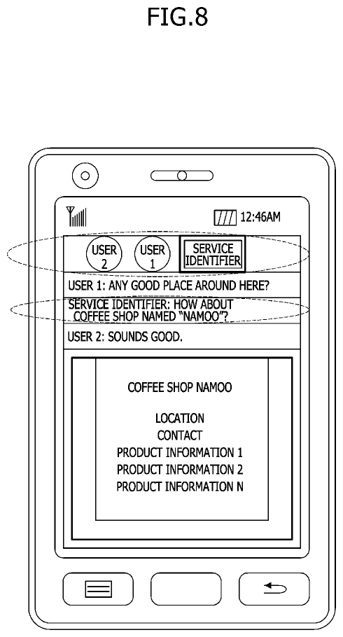

FIG. 8 is an example diagram illustrating operation of a message sharing system according to a fifth embodiment of the present invention.

As shown in FIG. 8, according to this embodiment, when users (e.g., group users who use a service (e.g., shopping or navigation)) have a conversation in a chat channel of a main APP, the message sharing device 100 (i.e., a message sharing device encompassing the message sharing server 200) enables each user to use a function of a heterogeneous APP while conversation content of the chat channel (i.e., the chat channel of the main APP) is shared with the heterogeneous APP.

A person in charge of a service (e.g., shopping mall or reservation for a coffee shop) which can be used through the heterogeneous APP may be a chat bot (i.e., a message response robot which automatically responds to a message input by a user) or a terminal user who talks with the customer users through the main APP.

In the case of a chat bot, while a conventional art is configured to analyze a one-to-one talk between one service user and a chat bot on a service provider side, an embodiment of the present invention proposes analyzing a conversation among a plurality of service users and a chat bot on a service provider side.

According to this embodiment, in a process of calculating an associated APP, service, or product recommendation result, it is possible to use weights for keywords of respective users or labels when the keywords of the plurality of users are analyzed and the labels are given to the keywords.

For example, when there is a keyword mentioned by one of users who are communicating with each other and a keyword mentioned by three users, a triple weight may be given as an input value for calculation to the keyword mentioned by three users.

For example, an input value of a recommended algorithm expression from a conversation between one service user and a chat bot and an input value of a recommended algorithm expression from a conversation among a plurality of service users and a chat bot are compared as follows.

(Example 1 of Input Value Calculation)

Expression input value 1 recommending service selection in a one-to-one talk:

Y=F(k1, k2, k3, k4, . . . )

Here, kn indicates a mentioned keyword, and Y indicates a calculation result.

Expression input value 1 recommending service selection for reflecting a multiple-to-one user weight:

Y=F(UN1*k1, UN2*k2, UN3*k3, . . . )

Here, UNn indicates the number of users who have mentioned a corresponding keyword (kn).

(Example 2 of Input Value Calculation)

Expression input value 2 recommending service selection in a one-to-one talk:

Y=F(N1*k1, N2*k2, N3*k3, . . . )

Here, Nn indicates the number of times that a corresponding keyword (Kn) has been mentioned in a conversation.

Expression input value 2 recommending service selection for reflecting a multiple-to-one user weight:

Y=F(UN1*N1*k1, UN2*N2*k2, UN3*N3*k3, . . . )

Here, UNn indicates the number of users who have mentioned a corresponding keyword (kn), and Nn indicates the number of times that a corresponding keyword (Kn) has been mentioned in a conversation.

(Example 3 of Input Value Calculation)

Expression input value 3 recommending service selection in a one-to-one talk:

Y=F(N1, k1, N2, k2, N3, k3, . . . )

Here, Nn indicates the number of times that a corresponding keyword (Kn) has been mentioned in a conversation.

Expression input value 3 recommending service selection for reflecting a multiple-to-one user weight:

Y=F(UN1, N1, k1, UN2, N2, k2, UN3, N3, k3, . . . )

Here, UNn indicates the number of users who have mentioned a corresponding keyword (Kn), and Nn indicates the number of times that a corresponding keyword (Kn) has been mentioned in a conversation.

The following is an example which includes user identifiers as input values so as to make user-specific analysis possible.

(Example 4 of Input Value Calculation)

Expression input value recommending service selection for reflecting a multiple-to-one user weight:

Y=F(U1, k11, k12, U2, k21, k22, U3, k31, k32, k33, . . . )

Here, Un indicates a user identifier, and Knn indicates a keyword mentioned by user n.

In example 3 and example 4 of input value calculation, input variables of F(x) are only listed without multiplication. This is intended to only input the variables so that a weight can be calculated in an F(x) process. The expressions shown as examples above are only for the purpose of describing that a weight can be calculated in various ways and are not intended to limit the calculation method.

For a case in which a human consultant or seller rather than a machine, such as a chat bot, participates in a conversation, keyword occurrence situations of users may be presented as shown in Table 1 below.

TABLE 1

| | | | | User-specific |
|---|---|---|---|---|
| | | | | accumulated |
| | k1 | k2 | k3 | value |
| U1 | 3 | 3 | 0 | 6 |
| U2 | 0 | 0 | 1 | 1 |
| U3 | 1 | 0 | 0 | 1 |
| Accumulated value | 4 | 3 | 1 | |
| Number of users who have | 2 | 1 | 1 | |
| mentioned corresponding | | | | |
| keyword | | | | |

[where Un: user identifier, Kn: keyword] As described above, according to this embodiment, when an identifier of a heterogeneous APP executed in a terminal (e.g., an APP identifier or a service identifier of the heterogeneous APP) belongs to a chat channel (or a chat group) of the main APP, the message sharing device 100 transmits messages generated among users in the chat channel (or the chat group) to the heterogeneous APP executed in terminals of the users as well.

Also, the message sharing device 100 (i.e., a message sharing device encompassing the message sharing server 200) according to this embodiment generates a message even in a heterogeneous APP and participates in the chat channel of the main APP such that a message generated in the heterogeneous APP may be shared (not only with group users of the heterogeneous APP but also with all users of the chat channel of the main APP) as a message of the main APP (i.e., the chatting APP).

Further, when a word (or a keyword) (e.g., a coffee shop) related to the heterogeneous APP is included in the chatting message, the message sharing device 100 (i.e., a message sharing device encompassing the message sharing server 200) may execute the heterogeneous APP (e.g., a search APP or web) related to the word, output the results (e.g., retrieved information), and share the results among chat channel participants (users).

When a service identifier of the heterogeneous APP used by the group or an identifier of the main APP (i.e., a chatting APP) is added as a group user through a function for forming the group, that is, in a process of adding group users, in the heterogeneous APP, a chat channel for users of a group formed in the heterogeneous APP is automatically created in the main APP (e.g., a messenger) as well. Therefore, the group users of the heterogeneous APP may be added to the chat channel of the main APP, or an invitation to the chat channel may be transmitted to the group users.

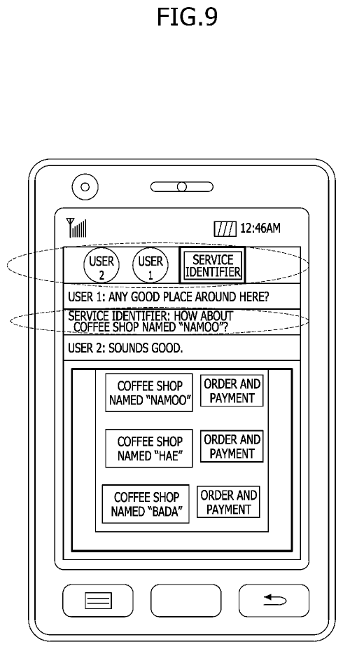

FIG. 9 is an example diagram illustrating operation of a message sharing system according to a sixth embodiment of the present invention.

As shown in FIG. 9, in the message sharing device 100 (i.e., a message sharing device encompassing the message sharing server 200) according to this embodiment, an output interface for simultaneously outputting information of a main APP and a heterogeneous APP to a screen (e.g., an interface which divides a screen display area and displays main APP information on one side and heterogeneous APP information on the other side) may be implemented.

For example, the message sharing device 100 (i.e., a message sharing device encompassing the message sharing server 200) according to this embodiment allocates a user interface space (or a screen display area) so that conversation content of a messenger (i.e., the main APP) may be simultaneously output to a payment APP for group purchase (i.e., the heterogeneous APP) in real time. Also, an existing message output space (or a screen display area) of the heterogeneous APP may be used in common.

The message sharing device 100 shares conversation content of respective users of a corresponding group with the payment APP for group purchase (i.e., the heterogeneous APP). Accordingly, users can make payments for purchase together with the users of the group while checking information exchanged through a messenger on the payment APP for group purchase (i.e., the heterogeneous APP) in real time.

When a service identifier of the heterogeneous APP used by the group or an identifier of the main APP (i.e., a chatting APP) is added as a group user through a function for forming the group, that is, in a process of adding group users, in the heterogeneous APP, a chat channel for users of a group formed in the heterogeneous APP is automatically created in the main APP (e.g., a messenger) as well. Therefore, the group users of the heterogeneous APP may be added to the chat channel of the main APP, or an invitation to the chat channel may be transmitted to the group users.

The present invention has been described above with reference to embodiments shown in the drawings. However, the embodiments are only examples, and those of ordinary skill in the art should appreciate that various modifications and equivalents can be derived from the embodiments. Therefore, the technical scope of the present invention should be determined by the following claims.

What is claimed is:

1. A system for sharing a message of an interactive chatting application, the system comprising:
a message sharing server configured to share, with at least one heterogeneous application, all or some of messages exchanged in an interactive chatting application for communicating with at least one other user by exchanging messages; and
a message sharing device configured to be connected online to the message sharing server and to receive information for sharing the messages or information for executing a message sharing function from a terminal.

2. The system of claim 1, wherein the message sharing server is implemented to perform a function of detecting a specific word or keyword included in the messages exchanged through a chat channel of the interactive chatting application.

3. The system of claim 1, wherein the message sharing server divides a screen display area of the terminal into at least two display areas and displays a screen in which messages of the interactive chatting application are exchanged and an execution screen of the heterogeneous application, or displays an existing screen display area of the heterogeneous application in common.

4. The system of claim 1, wherein the message sharing server is implemented to perform a function of detecting that a heterogeneous application preset to share messages of the interactive chatting application is executed in each user's terminal.

5. The system of claim 1, wherein the message sharing server is implemented to generate a message in a preset format on the basis of execution results of the at least one heterogeneous application and transmit the generated message through a chat channel of the interactive chatting application.

6. The system of claim 1, wherein when a message including a word or keyword related to a pre-designated heterogeneous application is detected in the messages exchanged through the interactive chatting application, the message sharing server automatically executes the related heterogeneous application or a heterogeneous application server by using the word or keyword included in the detected message.

7. The system of claim 6, wherein when execution of the heterogeneous application or the heterogeneous application server automatically executed by using the word or keyword is finished, the message sharing server converts execution results of the heterogeneous application into a pre-designated chatting message and outputs the pre-designated chatting message to a chat channel of the interactive chatting application.

8. The system of claim 1, wherein the message sharing server shares the messages exchanged in the interactive chatting application with a corresponding heterogeneous application or a corresponding heterogeneous application server through an identifier pre-registered in a chat channel of the interactive chatting application.

9. A method of sharing a message of an interactive chatting application using a message sharing system including a message sharing server configured to share messages exchanged through an interactive chatting application with at least one heterogeneous application and a message sharing device configured to be connected online to the message sharing server and to receive information for sharing the messages or information for executing a message sharing function from a terminal, the method comprising:
detecting, by the message sharing server, a message including a word or keyword related to at least one pre-designated heterogeneous application in the messages exchanged through the interactive chatting application; and
automatically executing, by the message sharing server, at least one corresponding heterogeneous application or heterogeneous application server by using the word or keyword included in the message.

10. The method of claim 9, wherein in order to share the messages exchanged through the interactive chatting application with the heterogeneous application, the message sharing server divides a screen display area of the terminal into at least two display areas and displays a screen in which messages of the interactive chatting application are exchanged and an execution screen of the heterogeneous application or displays an existing screen display area of the heterogeneous application in common.

11. The method of claim 9, wherein in order to share the messages exchanged through the interactive chatting application with the heterogeneous application, the message sharing server shares the messages exchanged through the interactive chatting application with a corresponding heterogeneous application or a corresponding heterogeneous application server through an identifier pre-registered in a chat channel of the interactive chatting application.

12. The method of claim 9, further comprising, when execution of the heterogeneous application or the heterogeneous application server automatically executed by using the word or keyword is finished, converting, by the message sharing server, execution results of the heterogeneous application or the heterogeneous application server into a pre-designated chatting message and outputting the pre-designated chatting message to a chat channel of the interactive chatting application.

13. The method of claim 9, wherein in order to automatically execute the heterogeneous application or the heterogeneous application server, the message sharing server applies, to the keyword, a weight calculated on the basis of the number of times that the same keyword has been mentioned and the number of users who have mentioned the same keyword in the messages exchanged through the chatting APP.

14. A method of sharing a message of an interactive chatting application using a message sharing system including a message sharing server configured to share messages exchanged through an interactive chatting application with at least one heterogeneous application and a message sharing device configured to be connected online to the message sharing server and to receive information for sharing the messages or information for executing a message sharing function from a terminal, the method comprising:
receiving, by a heterogeneous application server, a chat channel addition request message for requesting to add a service identifier of a heterogeneous application or an identifier of the interactive chatting application to a chat channel as a group user through the heterogeneous application in the terminal;
transmitting, by the heterogeneous application server, a chat channel creation request message for requesting to create a chat channel including, as interlocutors, group users who have been requested to be added to the chat channel as the group user to the interactive chatting application server; and
creating, by the interactive chatting application server, a chat channel according to the chat channel creation request message and adding the service identifier of the heterogeneous application in the terminal or the identifier of the interactive chatting application to the chat channel.
